(19) United States
(12) Patent Application Publication
(10) Pub. No.: US 2018/0072201 A1
(43) Pub. Date: Mar. 15, 2018

(54) ARMREST APPARATUS AND VEHICLE WITH THE ARMREST APPARATUS

(71) Applicant: GM GLOBAL TECHNOLOGY OPERATIONS LLC, Detroit, MI (US)

(72) Inventor: Marten WITTORF, Ruesselsheim (DE)

(73) Assignee: GM GLOBAL TECHNOLOGY OPERATIONS LLC, Detroit, MI (US)

(21) Appl. No.: 15/698,233

(22) Filed: Sep. 7, 2017

(30) Foreign Application Priority Data
Sep. 12, 2016 (DE) 102016011206.9

(51) Int. Cl. B60N 2/46; B60R 7/04

(52) U.S. Cl. CPC B60N 2/4686; B60R 2011/0014; B60R 7/04

(57) ABSTRACT

An armrest apparatus for a vehicle with a console is disclosed. The console includes a console body with a holding space. The armrest apparatus includes an armrest swivel-mounted around a swivel axis for positioning between a first state and a second state. In the first state, the armrest conceals the holding space in such a way that an arm can be laid onto the armrest. In the second state, the armrest is positioned within the console body to reveal the holding space.

### CROSS-REFERENCE TO RELATED APPLICATION

This application claims priority to German Patent Application No. 102016011206.9, filed Sep. 12, 2016, which is incorporated herein by reference in its entirety.

### TECHNICAL FIELD

The present disclosure pertains to an armrest apparatus for a vehicle and a vehicle with the armrest apparatus.

### BACKGROUND

Many vehicles have armrests that are position between two seats and are height adjustable. For example, DE 10 2007 033 532 A1 discloses an apparatus to adjust a middle armrest for a vehicle, in particular, for a driver's seat with a holder that supports the middle armrest at a certain position. The armrest is forcibly actuated in a guide mechanism for height adjustment in a vertical or Z-direction and for proportional horizontal adjustment in a longitudinal or X-direction of the middle armrest that runs parallel to the longitudinal axis of the vehicle.

### SUMMARY

The present disclosure provides a functionally improved armrest for a vehicle. Preferred and/or beneficial embodiments of the present disclosure are set forth in the following description and the included drawings. An armrest apparatus for a vehicle, preferably for a passenger car or a truck is described. The armrest apparatus may be configured to be positioned between a driver's seat and a passenger seat of the vehicle. As an alternative and/or additionally, the armrest apparatus may be configured to be positioned on a back seat of the vehicle.

The armrest apparatus includes a console having a console body with a holding space. The console is preferably made of plastic and/or synthetic resin. For instance, the console is made by an injection molding process. More preferably, the console is a three-dimensional body. The holding space is formed into the console body as a recess. The console body may be configured as a single piece. As an alternative and/or additionally, the console body may be configured in several pieces positioned to form the holding space. The holding space includes a floor, which includes structural elements to hold an object in a slip-resistant manner or store one. The holding space may be configured to be large enough to hold objects with a diameter of at least a 0.5-litre drinking bottle. Furthermore, the console body may include further elements, such as an ashtray or grip recesses configured in such a way that a driver/or a passenger can grip into these with their hand.

The armrest apparatus includes an armrest positionable in at least a first state and a second state. The armrest may also be positionable in more than two states. The armrest includes a carrier forming a structural element and accommodating a supporting surface. The supporting surface is, for example, a fabric cover, on which a driver and/or passenger of the vehicle can lay their forearm. The armrest may also include operational controls for controlling electronic and/or mechanical components of the vehicle via the operational controls.

The armrest is swivel-mounted around a swivel axis for changing the state of the armrest. For example, the armrest may be swivel-mounted so that changing between a first state and a second state is made possible. The swivel axis is positioned at a single level that is perpendicular to the vehicle's direction of travel. The swivel access may be aligned with the vehicle width. The armrest can be swiveled around the pivot access at an angle of greater than 45 degrees, more preferably, at an angle of greater than 90 degrees and, in particular, at an angle of greater than 180 degrees. The first state is also called the support state and the second state is also called the storage state. The armrest may include latch elements in order to maintain the armrest in the first and/or the second state. The armrest may also include unlocking elements that release the latch elements so that changing between the first and second state is enabled.

In the first state, the armrest is positioned relative to the holding space in such a way to cover the holding space and an arm can be placed on the armrest. The width of the armrest may be configured so that two forearms can be laid next to each other on the armrest. The armrest partially and/or fully covers the holding space in the first state. The armrest may be positioned to be spaced away from the holding space in the first state so that at least a 0.5-litre drinking bottle can be positioned between the floor of the holding space and the armrest. As an alternative, the armrest may be positioned directly over the holding space in the first state so that the holding space and the console are in contact with one another and/or have an interlocking connection.

The second state of the armrest may be characterized in such a way that the armrest reveals the holding space and may be positioned in a concealed manner within the console body. In the second state, the armrest may be positioned within the console body at least section by section. As an alternative, in the second state, the armrest may be positioned fully within the console body. The holding space being revealed by the armrest is intended to mean that the armrest no longer covers the holding space so that the holding space is completely exposed when viewed from above and access to the holding space is not restricted. In the second state, the armrest may be positioned under the holding space within the console body section by section.

Within the scope of the present disclosure, the armrest apparatus includes a holding space. The armrest can cover the holding space and/or can be stowed away within a console of the armrest apparatus. The armrest apparatus according to the present disclosure can therefore provide a holding area within the console available that is significantly larger, since the holding space or the storage space is not restricted by the armrest. Furthermore, the present disclosure makes it possible to stow away the armrest when not being used so that it is not visible and so that the holding space remains continuously unblocked.

In an exemplary embodiment of the present disclosure, the armrest is configured as a rigid body. More preferably, the armrest is configured as a dimensionally stable and/or non-malleable component. The armrest as a rigid body is made of a metal body or plastic body for example. The armrest may be configured in a bend-resistant manner as a rigid body.

In another embodiment of the present disclosure, the armrest may be configured as an elastic body. For example, the elasticity modulus of the armrest is less than one gig pascal (GPa), more preferably, less than 0.1 GPa and in particular, less than 0.01 GPa. The elastic body has bending strength so that the armrest is dimensionally stable in the first state and an arm can be laid on the armrest. The elastic body may be squeezed and/or pressed together into the second state and positioned within the console body so that it can be stowed away within the console body in a space-saving manner.

In an exemplary embodiment of the present disclosure, the armrest may adopt more than two states. The armrest can be adjusted between the plurality of states in a continuously variable manner. For example, the plurality of states of the armrest constitute variable degrees of the armrest covering the holding space. As an alternative and/or additionally, the armrest has a plurality of states where the plurality of states include locking positions and/or the degree of covering the holding space, at which points the armrest adopts a stable position. For example, the armrest may only be brought out of the stable positions by exerting an elevated level of force to bring it to the next and/or another state. If the armrest has a plurality of states that do not form locking positions, the armrest is continuously adjustable between the states. The force to change between two states is constant when adjusting between the continuously variable states.

The console of the armrest apparatus may include a guide recess to guide the armrest. For example, the guide recess may be configured as a guide rail and/or a guide groove. In particular, the guide recess specifies the path the armrest must take when changing between states. More preferably, the guide recess runs from a surface of the console body into the console body in order to end up under the holding space. In an advantageous way, the guide recess ensures easy changing between a first and a second state of the armrest without the risk of detaching.

An exemplary embodiment of the present disclosure provides for two sidewall formations aligned with the vehicle's direction of travel. The sidewall formations are one-piece or multi-piece components respectively. The sidewall formations may be flat formations with a thickness of less than five millimeters (mm). The sidewall formations are preferably rigid bodies such as plastic components. The holding space is positioned between the sidewall formations and housed by the sidewall formations and the armrest.

In an exemplary embodiment of the present disclosure, the console includes two sidewall holder openings to accommodate the sidewall formation. In the second state, the sidewall formation is positioned in the sidewall holder opening. The sidewall formation may be a slot-shaped configuration with a slot width somewhat wider than the thickness of the sidewall formation—for example 1.5 times the thickness of the sidewall formation. The longitudinal stretch of the sidewall holder openings is preferably aligned with the vehicle's direction of travel and/or longitudinal stretch of the holding space. Furthermore, the sidewall holder opening may extend from the surface of the console body that the armrest faces to the swivel axis.

The sidewall holder openings may include guide channels for the specific positioning of the sidewall formation in the first and/or second state. The guide channels are, for example configured to be staircase-shaped. The thickness of the sidewall holder opening decreases in the direction of travel from the backside of the vehicle to the front side of the vehicle. For example, the step heights of the staircase-shaped guide channels are configured in accordance with the thickness of the sidewall. As an alternative, the guide channels are configured to be ramped-shaped. The width of the sidewall holder openings continuously decreases from the back to the front of the vehicle in the direction of travel.

In an exemplary embodiment of the present disclosure, the sidewall formation has a plurality of spoke elements. The spoke elements may be configured for developing a support function for the armrest and the console body and/or the swivel axis. The spoke elements may be rigid, stiff and/or bend resistant. The spoke elements may be configured as long components such as metal and/or plastic rods. As an alternative and/or additionally, the spoke elements may be long flat components such as a thin, wedge-shaped segments. The thickness of the spoke elements may be less than five millimeters.

In an exemplary embodiment of the present disclosure, the spoke elements are connected in such a way that the spoke elements are pulled into their position adjacent to one another when changing from the first to the second state. More preferably, the spoke elements are configured to fan out when changing from the second state to the first state. The spoke elements may be fastened to the swivel axis. The spoke elements are fanned out all around the swivel axis. For example, the spoke elements are connected to each other via connection pins in elongated holes or embossments that intertwine with one another. The spoke element adjacent the front side of the vehicle may be configured to pull the other spoke elements when changing from the second state to the first state.

In an exemplary embodiment of the present disclosure, the side formation may be configured to form a limited opening to the holding area in the first state. Both side formations together with the armrest form a housing for the holding space. The housing has an opening to the holding space. The opening to the holding space is positioned in the vehicle's direction of travel. As an alternative and/or additionally, the opening to the holder area is positioned toward the back side of the vehicle. The opening to the older area may be configured to be rectangular. As an alternative, the opening has a circular shaped cross-section or a cross-section of any shape. The limited opening may include a surface greater than 5 cm², preferably greater than 30 cm² and in particular, greater than 100 cm² but smaller than 200 cm².

The present disclosure also provides a vehicle with the armrest apparatus as described above. For example, the vehicle may be a passenger car or truck. The armrest apparatus is y positioned between the driver's seat and the passenger seat of the vehicle. As an alternative and/or additionally, the armrest apparatus is positioned on a back seat of the vehicle.

### BRIEF DESCRIPTION OF THE DRAWINGS

The present disclosure will hereinafter be described in conjunction with the following drawing figures, wherein like numerals denote like elements.

FIG. 1 is a perspective top view of a first exemplary embodiment of an armrest apparatus;

FIG. 2 is a side top view of the armrest apparatus at FIG. 1:

FIG. 3 shows a sectional view of the armrest apparatus from FIG. 1:

FIGS. 4a, 4b and 4c show the spoke elements with bar sections;

FIGS. 5a, 5b and 5c show the spoke elements with elongated holes;

FIGS. 6a and 6b show a second exemplary embodiment of an armrest apparatus.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

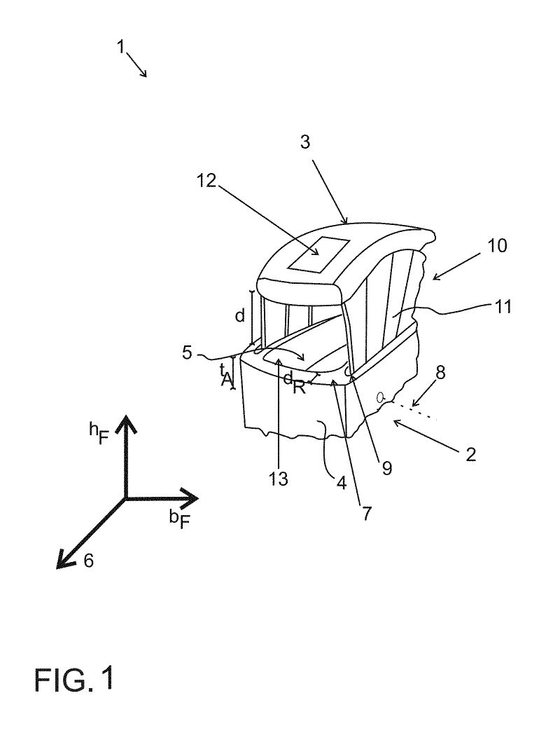

FIG. 1 is a perspective top front view of an armrest apparatus 1; In particular, the armrest apparatus 1 can be integrated into a passenger car or a truck. The armrest apparatus 1 is positioned between the driver's seat and the passenger seat. As an alternative and/or additionally, the armrest apparatus 1 may be positioned on the back seat of a passenger car and/or a truck.

The armrest apparatus 1 includes a console 2 and an armrest 3. The console 2 may be configured as a three-dimensional rigid plastic body. The console 2 includes a console body 4 and a holding space 5 is formed in the console body 4. The holding space 5 may be configured as a cuboid recess, the longitudinal extent oriented in the direction of travel 6. The length along the longitudinal direction of the cuboid holding space 5 is chosen in such a way that the holding space 5 in the console body 4 is limited by a holding space edge 7. The holding space edge 7 has a thickness d_{R} of more than one centimeter. The holding space 5 has a depth tA. The depth t_{A} of the holding space 5 is evenly aligned with the vehicle height h_{F}. The depth of the holding space 5 is greater than five centimeters. The console body 4 includes a swivel axis 8. The swivel axis 8 in the console body 4 is positioned under the holding space 5. The swivel axis 8 is evenly aligned with the vehicle width and is therefore perpendicular to the direction of travel 6 and to the vehicle height. The console body 4 includes two sidewall holder openings 9. The sidewall holder openings 9 are designed as slot-shaped openings in the console body 4. The slot-shaped openings stretch along the direction of travel 6. The widths of the sidewall holder openings 9 are within a range of one millimeter to a few centimeters. The sidewall holder openings 9 stretch to the swivel axis 8 within the console body 4.

A sidewall formation 10 is attached to the swivel axis 8 on both sides of the holding space 5 along the direction of travel 6. The sidewall formation 10 includes a plurality of spoke elements 11 respectively. The spoke elements 11 are swivel-mounted around the swivel axis 8. More preferably, the spoke elements 11 can be pivoted around the swivel axis 8 at an angle within a range between zero and one-hundred-eighty degrees. The spoke elements 11 are connected to the swivel axis 8 in such a way that these lie on one another formed in stacks and can be pulled away from the stack-formation in a fan shape. The sidewall formation 10 and/or the spoke elements 11 act as spacers to separate the armrest 3 from the console 2. The armrest 3 is a rigid body and more preferably a one-piece rigid body. A support surface 12 is integrated into the armrest 3. The support surface 12 forms a soft surface, on which a driver can support his forearm. Here, the armrest 3 is shaped as a ring segment. The ring segment covers an angular range of ninety degrees. As an alternative and/or additionally, the armrest 3 may be a ring segment within an angular range between twenty degrees and one-hundred-eighty degrees. The armrest 3 is positioned away from a surface of the console 2 at a distance d. The distance d is more preferably chosen in such a way that a driver can grip through a limited opening 13 using his hand. The limited opening 13 is more preferably limited by the armrest 3, the console 2 and both sidewall formations 10. The depth tA of the holding space 5 and the distance d are chosen in such a way that a 0.51 drinking bottle can be positioned in the holding space 5. The drinking bottle does not come into contact with the armrest 3 when the armrest 3 is used as a cover.

The armrest apparatus 1 is shown in this figure in a first state. The first state the state is where the armrest 3 conceals the holding space 5 and covers it. The armrest apparatus 1 includes a second state. The second state is the state where the armrest 3 does not cover the holding space 5, but is partially or fully positioned within the console 2.

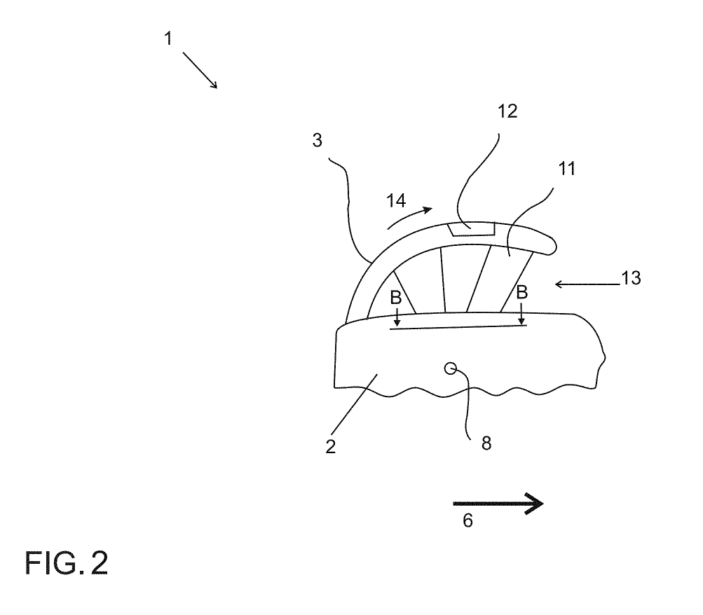

FIG. 2 shows a lateral view of the armrest apparatus 1 from FIG. 1. The console 2 with the console body 4 is shown section by section, whereby it is evident that the console body is a cuboid-shaped body. The swivel axis 8 runs perpendicularly to the drawing level and is perpendicular to the direction of travel 6. The spoke elements 11 of the sidewall formation 10 all run radially to the swivel axis 8. The spoke elements 11 are attached to the swivel axis 8. The spoke elements 11 can more preferably be pivoted around the swivel axis 8. The spoke elements 11 connect the swivel axis 8 to the armrest 3. The armrest 3 is a shaped as a corrugated body and as a circular segment or as a ring segment in this exemplary embodiment. The ring segment and/or the armrest 3 are attached to the swivel axis 8 via the spoke elements 11 so that swiveling the armrest 3 leads to swiveling the spoke elements 11 and/or vice versa. An arrow indicates the direction of the change of state 14 from a second state to the first state. Changing from the second to the first state corresponds to the method of the armrest 3 for going out of the console body 2 so that the armrest 3 covers the holding space 5. Inversely, the armrest 3 can be moved against the direction of changing state 15 from state one to state two, which corresponds to retracting the armrest 3 into the console body 4. The dashed lines show the course of the armrest 3, at least section by section, within the console body 4 for the second state.

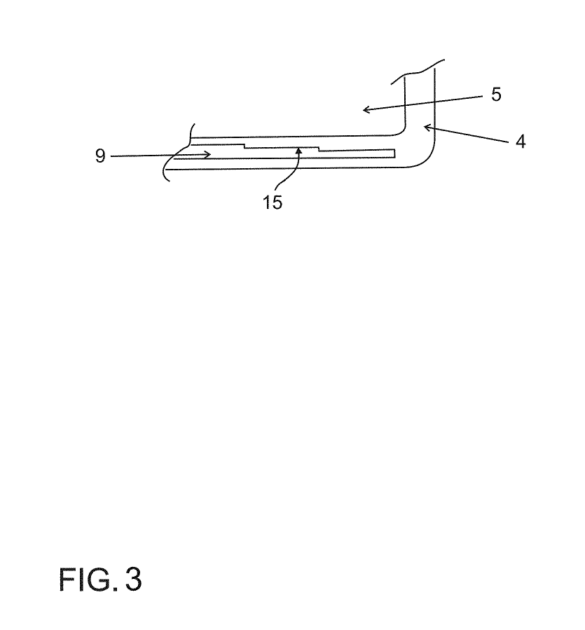

FIG. 3 shows a section of the armrest 1 from FIG. 2 along line BB. This section shows part of the holding space 5 as well as the limiting holding space edge 7. Along the direction of travel 6, within the holding space edge 7, a sidewall holder opening 9 is drawn with a guide channel 15. The guide channel 15 and/or the sidewall holder opening 9 are/is slot-shaped, positioned in the holding space edge 7 along the direction of travel 6. Here, the guide channel 15 is formed in steps. The steps are positioned in such a way that the width of the side wall holder openings decrease in the direction of travel 6. The height of a step is preferably the thickness of the sidewall holder openings 9 and/or slightly more. The step-shaped structure of the guide channel 15 has been formed to hold a plurality of spoke elements 11 as a stack if required, for example, when pressing together or when changing the armrest 3 from the first to the second state. For example, only one spoke element 11 has to be held at the very front position along the direction of travel. A step position away from it against the direction of travel 6, already two spoke elements must be held when pressing together. For a sidewall formation 10 with n spoke elements 11, the distance and/or width of the guide channel at the n^{th} step, n times the thickness of a sidewall formation 10.

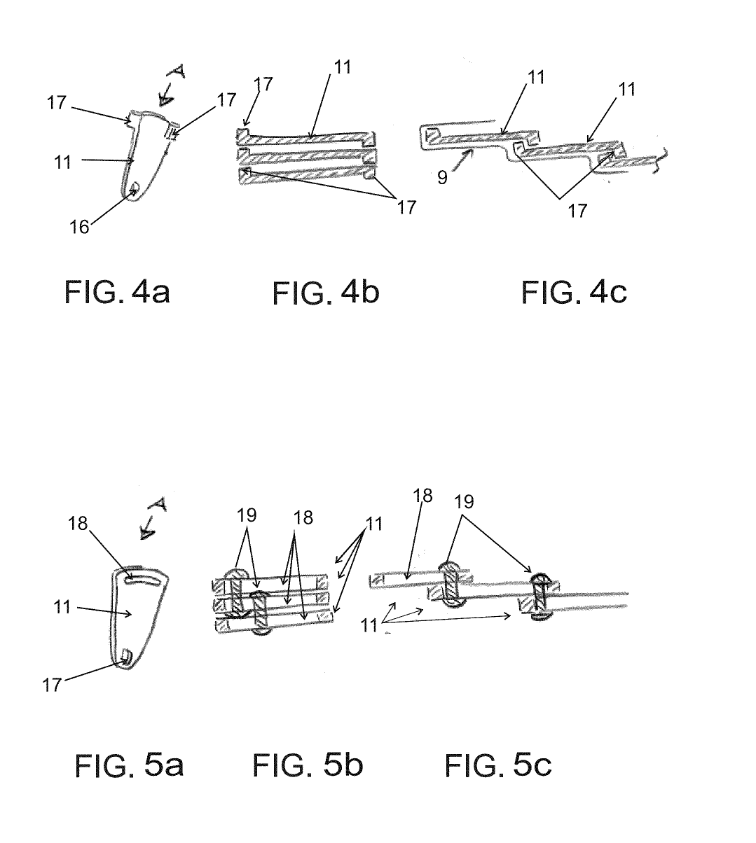

FIG. 4a shows a section of a spoke element 11 in detail. The spoke element 11 is formed as a circular-segment piece. The spoke element 11 has an inner radial pivot point 16 and bar sections 17 radially, on the outside. The bar sections 17 are spaced away from the flat stretch of the spoke element 11. Thereby, the bar segments 17 are each spaced away from the flat spoke element 11 in an opposing direction.

FIG. 4b shows a top view of the spoke element 11 from FIG. 4a in the A-direction. FIG. 4b furthermore shows a top view of A entailing three spoke elements 11. The three spoke elements 11 are stacked. This stack-shaped arrangement of the spoke elements 11 is preferably present in the second state of the armrest apparatus 1. The spoke elements 11 have a Z-shaped form when viewed from above. The spoke elements 11 are positioned with the same orientation in the stacked state.

FIG. 4c shows the stack of spoke elements 11 from FIG. 4b pulled out, as they are in the first position for example. In the extracted state, to spoke elements 11 are each arranged as contour pairs, or as interlocking pairs. More preferably, it is possible for a spoke element 11 to slide along the spoke element 11 lying beneath or above. The area in which a spoke element 11 can slide and another spoke element 11 is limited by the bar sections 17. Furthermore, FIG. 4c shows part of the guide channel 16 that is also been formed in the shape of steps. The width and/or the height of a step of the guide channel 16 corresponds to the thickness of a spoke element 11 minus the height of the bar segment 17.

FIG. 5a shows another exemplary embodiment of a spoke element 11. The spoke element 11 in this embodiment has an elongated whole 18. The elongated whole 18 is radially positioned on the outside. The pivot point 16 is radio positioned in the inside in the circular-sector-shaped switch element. The elongated hole 18 within the spoke element 11 is particularly bent in a circle shape according to the sector element.

FIG. 5b shows a top view of three spoke elements 11 from FIG. 5a in the A-direction. The three spoke elements 11 are connected to each other by the connection pins 19. The connection pins 19 connect each of the two adjacent spoke elements 11. The connection pins 19 run into the elongated holes 19 of the adjacent spoke elements 11 involved. Due to the connection of the spoke elements 11 using the connection pins 20, it is possible to push the spoke elements 11 against each other.

FIG. 5c shows the stack of spoke elements 11 from FIG. 5b in an extracted state, as this is in the first state of the armrest apparatus 1 for example. In the extracted state, the connection pins 19 that run into the same elongated hole 19 are each positioned at opposite ends of the elongated hole 19. By pressing the extracted spoke elements 11 into the direction of the second state, the stack of spoke elements 11 is restored as shown in FIG. 5b.

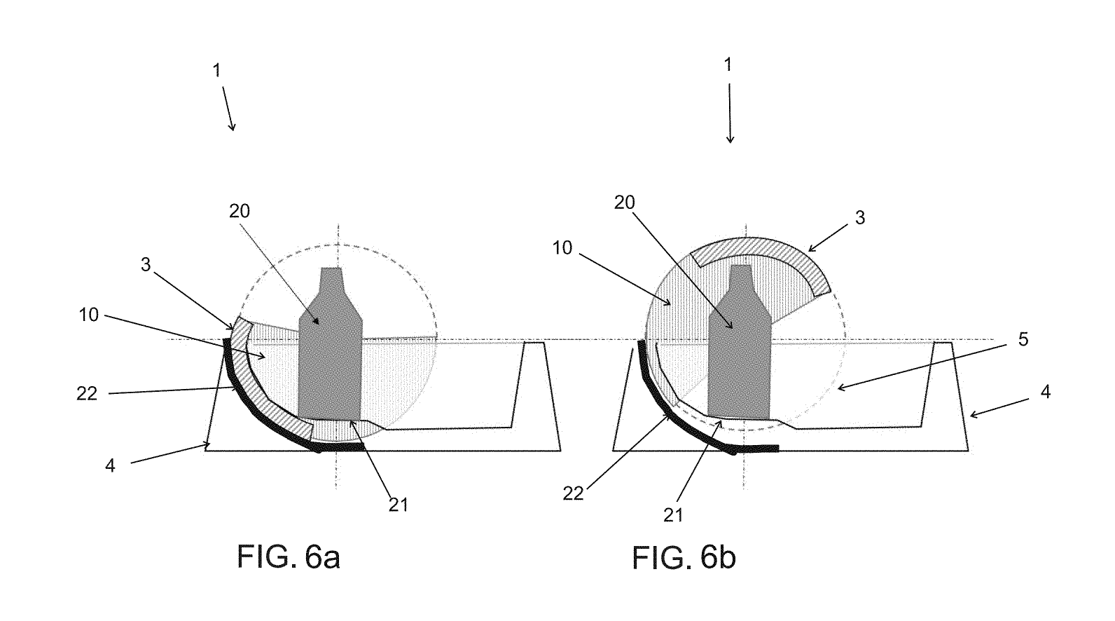

FIG. 6a shows the armrest apparatus 1, in which there is a drinking bottle 20. In the case of the drinking bottle 20, it has to do with a 0.5-litre drinking bottle. The drinking bottle 20 has been set on the floor 21 of the holding space 5. In this figure, the armrest apparatus 1 is in the second state since the armrest 3 is located almost completely within the console 2. In this state, the armrest 3 is in contact with the guide recess 22. The guide recess 22 may be configured to guide the armrest 3 when changing from a first to a second state without getting caught. For example, this is shaped as a guide channel or as a guide rail. Here, the sidewall formation 10 is shaped as a continuous sidewall formation 10, more preferably, as a disc-shaped cover. By rotating the armrest 3 around the swivel axis 8, the armrest apparatus 1 can be brought into the first state.

The first state of the armrest apparatus 1 from FIG. 6a is shown in FIG. 6b. Thereby, the armrest 3 covers the holding space 5 and the drinking bottle 20 section by section. Furthermore, the sidewall formation 10 covers the drinking bottle in a lateral view. The armrest 3 has been arranged in this position in such a way that the driver can support his arm on it. Here, the armrest 3 forms a ring segment, whereby this ring segment involves an angle of approximately 90°. Here, the sidewall formation 10 is formed as a semi-circular flat element on two opposite sides of the holding space 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12 (canceled)

13. An armrest device for a motor vehicle comprising:
a console having a console body defining a holding space; and
an armrest swivel-mounted to the console and positionable between a first state such that the armrest covers the holding space and provides an armrest surface configured to support an arm and a second state such that the armrest is positioned within the console body in a concealed manner and the holding space is revealed.

14. The armrest apparatus according to claim 13, wherein the armrest comprises a rigid one-piece body.

15. The armrest apparatus according to claim 13, wherein the armrest comprises an elastic body.

16. The armrest apparatus according to claim 13, wherein the armrest is positionable in a continuously variable manner between the first and second states.

17. The armrest apparatus according to claim 13, wherein the console further comprises a guide recess configured to receive and guide the armrest.

18. The armrest apparatus according to claim 13, wherein the console further comprises first and second of sidewalls aligned in a longitudinal direction adjacent the holding space.

19. The armrest apparatus according to claim 18, wherein the console further comprises a first sidewall holder opening configured to accommodate the first sidewall and a second sidewall holder opening configured to accommodate the second sidewall, wherein the sidewalls are arranged in the sidewall holder openings in a concealed manner when the armrest is in the second state.

20. The armrest apparatus according to claim 19, wherein each of the first and second sidewall holder openings comprise a guide channel for positioning the sidewalls in the first state or second state.

21. The armrest apparatus according to claim 18, wherein the sidewalls comprise a plurality of spoke elements.

22. The armrest apparatus according to claim 21, wherein the spoke elements are collapsibly interconnected, wherein the spoke element extend from the console when the armrest is in the first state and retract into the console when the armrest is in the second state.

23. The armrest apparatus according to claim 13, wherein the armrest and the first and second sidewalls form a limited opening to the holding space in the first state.

24. A vehicle comprising a first seat, a second seat and an armrest apparatus according to claim 13 operably positioned between the first and second seats.
